(19) United States
(12) Patent Application Publication
(10) Pub. No.: US 2009/0145184 A1
(43) Pub. Date: Jun. 11, 2009

(54) APPARATUS, SYSTEM, AND METHOD FOR OPENING A SECURITY LOCK SLOT OF AN ELECTRONIC DEVICE

(75) Inventor: Nixon Cheaz, Cary, NC (US)

Correspondence Address: KUNZLER & MCKENZIE, 8 EAST BROADWAY, SUITE 600, SALT LAKE CITY, UT, 84111, US

(73) Assignee: International Business Machines Corporation, Armonk, NY (US)

(21) Appl. No.: 11/951,128

(22) Filed: Dec. 5, 2007

(51) Int. Cl. E05B 15/00; G06F 21/00

(52) U.S. Cl. 70/266; 726/34

(57) ABSTRACT

A computer program product, apparatus, and system are disclosed for opening a security lock slot of an electronic device. The apparatus for opening a security lock slot of an electronic device is provided with a plurality of modules configured to functionally execute the necessary steps to receive a lock slot command and a user credential, authenticate the user credential, and signal the security lock slot module such that the security lock slot module opens the security lock slot to disengage the tether anchor in response to a positive authentication and the lock slot command comprising an open instruction. The computer program product, apparatus, and system thereby allow a user to disengage a standard device cable lock from an electronic device by electronic means without damaging the case of the electronic device.

### BACKGROUND OF THE INVENTION

1. Field of the Invention

This invention relates to a security lock slot and more particularly relates to opening a security lock slot of an electronic device.

2. Description of the Related Art

Many modern electronic devices are equipped with a security lock slot, especially smaller, portable devices such as laptops, LCD screens, or even some desktop computers. The slot, usually a three millimeter by seven millimeter opening configured for an external lock, is often located in the case of the electronic device. Although several types of locks exist, Kensington® is the industry standard. Kensington® locks typically include a T-shaped latch which is capable of rotation by inserting a key into the lock head and turning the key or by setting a lock combination in the lock head.

A security lock is usually not intended to provide tight security, but rather to act as a deterrent to someone searching for an easy theft. The lock may be forcibly removed, often damaging the case of the electronic device. Security locks are used by individuals, libraries, schools, electronics retailers, businesses, or anywhere in which electronic devices may be at risk of theft.

### BRIEF SUMMARY OF THE INVENTION

A computer program product is presented for opening a security lock slot of an electronic device. The operations of the computer program product may comprise receiving a lock slot command and a user credential by way of a software user interface of an electronic device comprising a security lock slot module configured to disengage a tether anchor in response to an electronic signal, authenticating the user credential, and sending an electronic signal to the security lock slot module such that the security lock slot module opens the security lock slot to disengage the tether anchor in response to a positive authentication and the lock slot command comprising an open instruction. Additionally, the computer program product may engage a tether anchor in response to an electronic signal, the computer program product operations further comprising closing the security lock slot in response to the lock slot command comprising a close instruction. In one embodiment, the user credential comprises a password.

In a further embodiment, the computer program product may be configured such that the user interface comprises a software interface selected from the group consisting of a BIOS user interface, an operating system user interface, an application user interface, and an electronic device configuration user interface. In one embodiment, the security lock slot is configured such that rotation of the latch within the security lock slot permits the latch to disengage with the security lock slot, the tether anchor further comprising a lock connecting the security tether and the latch, the lock configured to retain the latch in a locked position relative to the security lock slot and rotate the latch to an unlocked position relative to the security lock slot. The security lock slot may also comprise an opening having a three millimeter height and a seven millimeter width.

In addition, an apparatus for opening a security lock slot of an electronic device is provided with a plurality of modules configured to functionally execute the necessary steps as described above in relation to the computer program product. These modules in the described embodiments include a software user-interface module, an authentication module, a security lock slot module, and a signal module. The security lock slot module, in one embodiment, may comprise a gate configured to raise and lower, a rack on the inside surface of the gate, and a pinion in contact with the rack, the pinion configured to turn to raise and lower the gate. The apparatus is further configured, in one embodiment, wherein the user credential comprises a user name and a password.

A system of the present invention is also presented for opening a security lock slot of an electronic device. The security lock slot module of the system may also comprise a gate configured to raise and lower, a rack on the inside surface of the gate, and a pinion in contact with the rack, the pinion configured to turn to raise and lower the gate. The lock slot may comprise an opening sized to receive a Kensington® standard cable lock device.

Reference throughout this specification to features or similar language does not imply that all of the features that may be realized with the present invention should be or are in any single embodiment of the invention. Rather, language referring to the features is understood to mean that a specific feature or characteristic described in connection with an embodiment is included in at least one embodiment of the present invention. Thus, discussion of the features and similar language, throughout this specification may, but do not necessarily, refer to the same embodiment.

Furthermore, the described features and characteristics of the invention may be combined in any suitable manner in one or more embodiments. One skilled in the relevant art will recognize that the invention may be practiced without one or more of the specific features of a particular embodiment. In other instances, additional features and advantages may be recognized in certain embodiments that may not be present in all embodiments of the invention.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating a laptop computer with a security lock slot;

FIG. 1B illustrates one embodiment of a security lock slot in the closed position;

FIG. 1C illustrates one embodiment of a security lock slot in the open position;

FIG. 2 is a cross-section view illustrating one embodiment of a tether anchor engaging a security lock slot;

FIG. 3 is a schematic block diagram illustrating one embodiment of an apparatus for opening a security lock slot of an electronic device;

FIG. 4 is a schematic flow chart diagram illustrating one embodiment of a method for opening a security lock slot of an electronic device in accordance with one embodiment of the invention; and

FIG. 5 is a detailed schematic flow chart diagram illustrating one embodiment of a method for opening a security lock slot of an electronic device in accordance with one embodiment of the invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

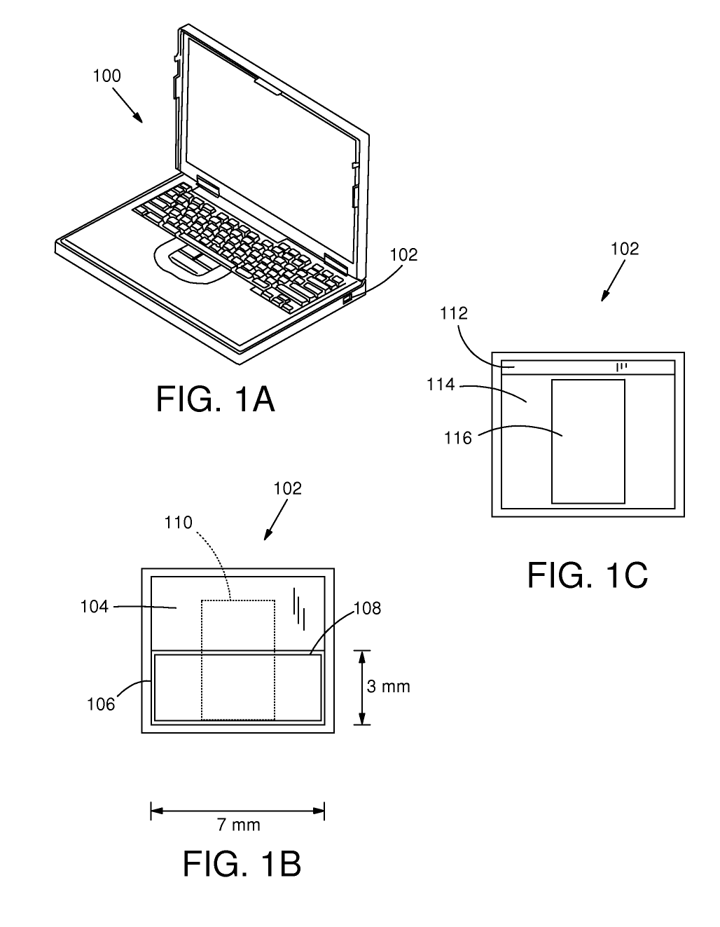

FIG. 1A is a perspective view illustrating a laptop computer 100 with a security lock slot 102 built into the case. Security lock slots are often made of metal, surrounded by a plastic housing, and secured within the frame of the electronic device. A typical Kensington® lock consists of an anchor and a T-shaped latch at the end of the anchor for insertion into a lock slot. The anchor may also have an attached lock or combination device, or a lock built into the anchor. Attached to the lock head and anchor is a tether or cable which has a small loop at the end. To secure an electronic device, the tether is looped around an unmovable object, the T-shaped latch is inserted into the lock slot of the device, and the key is inserted and turned to rotate the T-shaped latch. As the T-shaped latch is rotated within the lock slot the prongs of the latch are braced against the inside surface of the gate and the tether anchor becomes secured in the lock slot

Other electronic devices which may be configured with a security lock slot include, but are not limited to desktop computers, LCD screens, televisions, Personal Digital Assistants (PDAs), printers, projectors, and docking stations.

The present invention releases a standard cable lock from a security lock slot without a key or combination. Conventional standard cable locks and security lock slots are designed to be broken if needed in case of a lost key or broken lock. However, with the electronic release functionality provided by the present invention, the lock and/or security lock slot 102 may be strengthened.

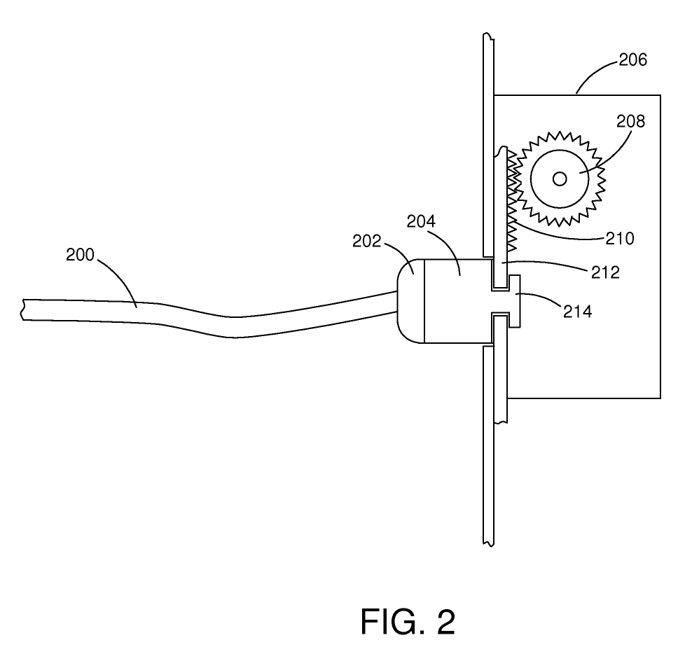

FIG. 1B shows one embodiment of a security lock slot 102 in the closed position. With the gate 104 in the closed position, the security lock slot 102 engages a latch 110 of a tether anchor (See FIG. 2). Furthermore, in this position, the security lock slot 102 permits the tether anchor to disengage when the latch 108 is rotated within the security lock slot 102 to align with the opening 106.

In the illustrated embodiment, the opening 106 has a width of seven millimeters and a height of three millimeters, or the standard size of a Kensington® style security lock slot opening. Depending on the manufacturer of the electronic device, some lock slot openings 106 may have a width of three millimeters and a height of seven millimeters.

FIG. 1C illustrates one embodiment of a security lock slot 102 in the open position. With the gate 112 in the open position, the security lock slot 102 may disengage the latch 116. Furthermore, in this position, the security lock slot 102 is configured such that rotation of the latch 116 within the security lock slot 102 is not necessary for the tether anchor to disengage with the security lock slot 102. If the owner of the electronic device has lost his key or has forgotten his combination, the lock may be removed from the electronic device 100 by opening the security lock slot 102 in this manner and thereby avoid having to damage the case of the electronic device 100.

In another embodiment, the security lock slot 102 is sized and shaped such that rotation of the latch 116 within the security lock slot 102 does not permit the latch 116 to disengage with the security lock slot 102. In this embodiment, the opening 106 is smaller than the latch 116, regardless of how the latch 116 is rotated. A library or office may use this embodiment to secure multiple desktop computers without cable locks, keys, or combinations as the latch 116 would not necessarily require the capability to rotate.

FIG. 2 illustrates a cross-section of one embodiment of security lock slot module 206 and an engaged tether anchor 204. The security lock slot module 206 includes the security lock slot 102 (See FIG. 1) fixed to the housing of the electronic device 100. In addition, the security lock slot 102 may be externally accessible by the tether anchor 204 to secure the electronic device 100 to the tether anchor 204. Furthermore, the inside of the security lock slot module 206 may comprise a gate 212 configured to open and close, a rack 210 on the inside surface of the gate 212, and a pinion 208 in contact with the rack 210, the pinion 208 configured to turn to raise and lower the gate 212.

The tether anchor 204 may have an attached or built-in key lock 202, a lock with a combination, or no lock. The lock 202 keeps the latch 214 from rotating when the latch 214 is in a locked position relative to the security lock slot 102. Releasing the lock 202 allows the latch 214 to rotate the latch 214 to an unlocked position relative to the security lock slot 102. This embodiment utilizes a standard Kensington® style lock.

The present invention permits the freeing of the Kensington® style lock without releasing the lock itself. This feature is helpful if the key for the lock or combination of the lock is lost or stolen. For example, a user who has released her security lock using the security lock slot module 206 to open the security lock slot 102 of her electronic device 100 may wish to secure her electronic device 100 again with the security lock. The user may insert the security lock tether anchor 204 and close the security lock slot 102 to engage the tether anchor 204. In this manner, a user may secure her electronic device 100 without using the key to the security lock. This procedure may be used by hotels, libraries, convention centers, and similar institutions to supply permanent tether anchors with no locks and non-rotating latches for users to secure their electronic devices. Alternatively, a fake or dummy cable lock made to look like a Kensington® style lock having non-rotating latches may be used to deter theft and still permit the user to free the electronic device 100 or engage the electronic device 100 using the security lock slot module 206.

The tether anchor 204 and lock 202 may have an attached security tether 200. The security tether 200 may be a flexible steel cable with a loop on the end used to secure the electronic device 100 to a desk, the wall, or any immovable object thereby preventing a thief from stealing the electronic device.

The gate 212 is in a lowered or closed position, thereby engaging a latch 214 of the tether anchor 204. If a lock with a rotating latch is used, a tether anchor latch 214 may comprise a standard T-shaped latch similar to the Kensington style latch or an L-shaped latch with a prong on one side. In addition, if the tether anchor 204 does not include a lock and the security lock slot module 206 will be used strictly to engage or disengage the tether anchor, a mushroom shaped latch or latch with a round disk at the end may be used. With a mushroom shaped latch, the security lock slot 102 must be in the open position as pictured in FIG. 1C for the tether anchor to disengage.

Inside the security lock slot module 206, the surface of the gate 212, includes a rack 210. A pinion 208 engages the rack 210 and turns to raise or lower the gate 212. The pinion 208 may be driven by an actuator activated by an electronic signal. The signal may cause the actuator to trigger a pin which releases a coil spring. The released coil spring may rotate the pinion 206 to open the gate. In a further embodiment, the actuator may trigger a pin to release the gate 212 which is raised by the force of a pretensioned coil spring. The gate 212 may be lowered, and the security lock slot closed, by a hardware switch that lowers the gate 212 and biases the spring. In one embodiment, the hardware switch may be activated as the user inserts a tether anchor latch 214 into the security lock slot 102. In another embodiment, an electronic controller may receive an electronic signal and drive an electronic motor comprising gears configured to rotate the pinion 208 to open and/or close the gate 212.

The security lock slot 102 may also be configured with two gates, one above the latch 214 as pictured in FIG. 2, and one below the latch 214. A gate below the latch 214 may include a similar rack and pinion design as the upper gate 212. To disengage the tether anchor 204, both an upper gate and a lower gate may move away from the latch 214.

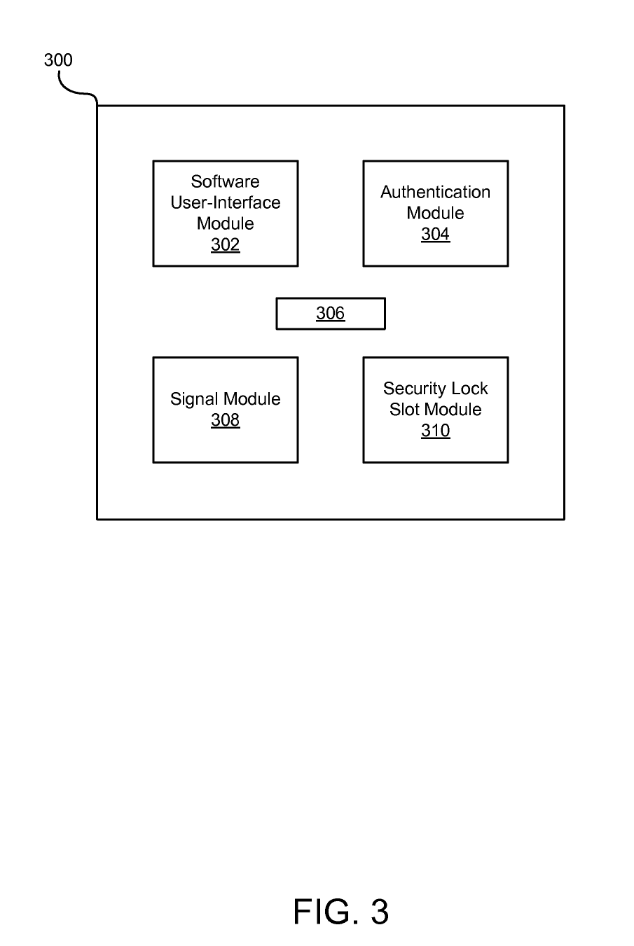

FIG. 3 illustrates one embodiment of an apparatus 300 for opening a security lock slot 102 of an electronic device 100. The apparatus 300 includes a software user-interface module 302, an authentication module 304, a user credential 306, a signal module 308, and a security lock slot module 310.

The software user-interface module 302 handles the request from the user to initiate operation of the security lock slot module 310 and the software user-interface module 302 also inputs a user credential 306. In one embodiment, the software user-interface module 302 is configured to receive a lock slot command and a user credential 306. The software user-interface module 302 may include a BIOS user interface, an operating system user interface, an application user interface, or an electronic device configuration user interface.

The user credential 306 may include a user name and a password. The user credential 306 may also comprise a password alone, a predetermined series of keystrokes, a thumbprint scan, a retina scan, a biometric or smartcard reading, voice recognition, or any other mode of authentication. In one embodiment, the authentication module 304 authenticates the user credential.

The lock slot command may be implicit in the launching of the software user-interface module 302. Therefore, in one embodiment, the activation of the software user-interface module 302 constitutes the receiving of an open lock slot command. In another embodiment, a lock slot command is selected or inputted by the user and may include an open lock slot command or close lock slot command.

An example of a software user-interface module is an application running on the operating system of a laptop computer, which, when launched, constitutes an open lock slot command and queries the user for a password 306. Certain electronic devices 100 such as an LCD monitor may not have an operating system or BIOS, and may not be capable of running a software application. In such electronic devices 100 a configuration user interface may include the software user-interface 302.

The signal module 308 receives a lock slot command and transmits an electronic signal to open or close the lock slot 102. In one embodiment, the signal module 308 is implemented in software and passes the electronic signal to the security lock slot module 310.

The security lock slot module 310 converts electronic signals from the signal module 308 into mechanical operations to move the gate 212 of the security lock slot 102. The security lock slot module 310 in one embodiment may include a combination of electrical, electromechanical, and/or mechanical components and may comprise the form and function of the security lock slot module 206 illustrated in FIG. 2. In one embodiment, the signal module 308 passes the electronic signal to an electronic controller coupled to a motor comprising gears configured to rotate a pinion 208 as described above. Alternatively, the signal module 308 passes the electronic signal to an electronic actuator which converts the electronic signal into mechanical motion, triggering a pin which releases a coil spring. The released spring rotates the pinion 206 to open the gate as described above.

In certain embodiments, the security lock slot module 310 may both raise and lower the gate and thereby both open and close the security lock slot 102 in response to an electronic signal from the signal module 308.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

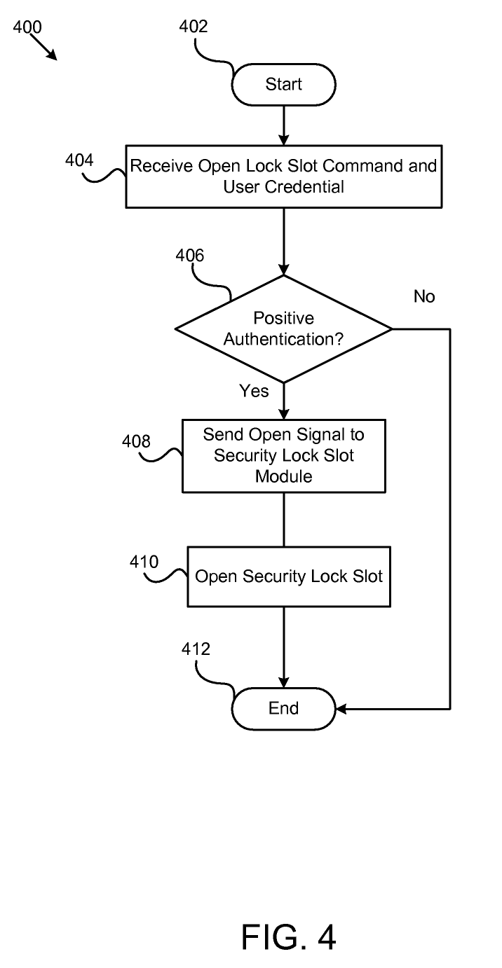

FIG. 4 illustrates one embodiment of a method 400 for opening a security lock slot of an electronic device. The method 400 may be implemented by the executed operations of a computer program product. The method 400 starts 402 when the software user-interface module 302 receives 404 an open lock slot command and a user credential. The authentication module 304 then authenticates 406 the user credential. If the authentication module 304 does not make a positive authentication, 406 the method 400 ends 412. Alternatively, if the authentication module 304 makes a positive authentication 406, the signal module 308 sends 408 an electronic signal to the security lock slot module 310. Next, the security lock module 306 opens 410 the security lock slot 102 and the method 400 ends 412.

For example, a user enters a password and user name into the BIOS software user-interface 302 of a laptop computer after, or along with, an open command. The authentication module 304 makes a positive authentication of the user credential. The signal module 308 sends an electronic signal to the security lock slot module 310 and the security lock slot module 310 opens the security lock slot 102 of the laptop computer. The user may then remove the latch 214 from the security lock slot 102.

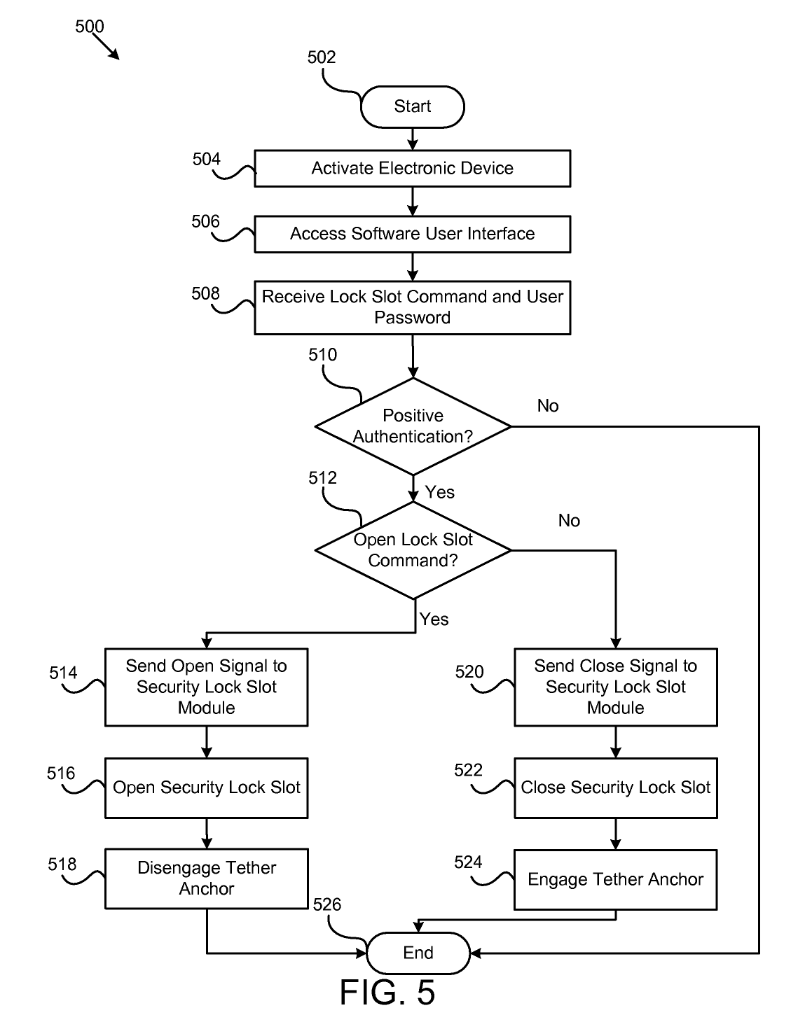

FIG. 5 illustrates one embodiment of a method 500 for opening a security lock slot 102 of an electronic device 100. The method 500 may be implemented by the executed operations of a computer program product. The method 500 starts 502 when the user activates 504 an electronic device 100 by pressing the on switch of the device 100. The user then accesses 506 the software user-interface module 302 of the electronic device 100 and enters a password and lock slot command. The software user-interface module 302 receives 508 the lock slot command and user password. The authentication module 304 then authenticates 510 the user password. In one embodiment, if the authentication module 304 makes a negative authentication, 510 the method ends 526. Alternatively, the authentication module 304 makes a positive authentication 510. If the signal module 308 determines 512 that the lock slot command is an open command, the signal module 308 sends 514 an electronic open signal to the security lock slot module 310. Inside the security lock slot module 310, an electronic controller receives the electronic signal and drives an electronic motor which rotates the pinion 208. The rotation of the pinion opens the gate and the security lock slot 102 opens 516. The user disengages 518 the tether anchor 204, and the method ends 526.

Alternatively, if the signal module 308 determines 512 that the lock slot command is a close command, the signal module 308 sends 520 a close signal to the security lock slot module 310. Inside the security lock slot module 310, an electronic controller receives the electronic signal and drives an electronic motor which rotates the pinion 208. The rotation of the pinion closes the gate and the security lock slot 102 closes 522. The security lock slot engages 524 the tether anchor 204, and the method ends 526.

For example, suppose a user does not have his security lock key but wishes to remove the lock from his desktop. The user turns on the desktop computer and accesses the software user-interface module 302 which is contained in the operating system of the desktop computer, in one embodiment. The user selects a lock slot open command from the user-interface and enters a password in response to a prompt. The user-interface module 302 receives the lock slot command and user password. Upon a positive authentication of the user password, the signal module 308 determines that the lock slot command is an open command and sends an open signal to the security lock slot module 310. The security lock slot module 310 opens the security lock slot 102, and the user is able to disengage his tether anchor 204 from the desktop without damaging the security lock slot 102 or the housing.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for opening a security lock slot of an electronic:
device, the operations of the computer program product comprising:
receiving a lock slot command and a user credential by way of a software user interface of an electronic device comprising a security lock slot module configured to disengage a tether anchor in response to an electronic signal, the security lock slot module having a security lock slot fixed to a housing of the electronic device, the security lock slot externally accessible by the tether anchor to secure the electronic device to the tether anchor;
authenticating the user credential; and
sending an electronic signal to the security lock slot module such that the security lock slot module opens the security lock slot to disengage the tether anchor in response to a positive authentication and the lock slot command comprising an open instruction, the tether anchor comprising a latch configured to engage the security lock slot in response to the security lock slot being closed and a security tether configured to discourage theft of the electronic device.

2. The computer program product of claim 1, wherein the security lock slot module is further configured to engage a tether anchor in response to an electronic signal, the computer program product operations further comprising closing the security lock slot in response to the lock slot command comprising a close instruction.

3. The computer program product of claim 1, wherein the user credential comprises a password.

4. The computer program product of claim 1, wherein the user interface comprises a software interface selected from the group consisting of a BIOS user interface, an operating system user interface, an application user interface, and an electronic device configuration user interface.

5. The computer program product of claim 1, wherein the security lock slot is configured such that rotation of the latch within the security lock slot permits the latch to disengage with the security lock slot, the tether anchor further comprising a lock connecting the security tether and the latch, the lock configured to retain the latch in a locked position relative to the security lock slot and rotate the latch to an unlocked position relative to the security lock slot.

6. The computer program product of claim 1, wherein the security lock slot comprises a three millimeter by seven millimeter opening.

7. An apparatus for opening a security lock slot of an electronic device, the apparatus comprising:
a software user-interface module configured to receive a lock slot command and a user credential;
an authentication module configured to authenticate the user credential;
a security lock slot module configured to disengage a tether anchor in response to an electronic signal, the security lock slot module having a security lock slot fixed to a housing of the electronic device, the security lock slot externally accessible by the tether anchor to secure the electronic device to the tether anchor; and
a signal module configured to signal the security lock slot module such that the security lock slot module opens the security lock slot to disengage the tether anchor in response to a positive authentication and the lock slot command comprising an open instruction, the tether anchor comprising a latch configured to engage the security lock slot in response to the security lock slot being closed and a security tether configured to discourage theft of the electronic device.

8. The apparatus of claim 7, wherein the security lock slot module is further configured to engage a tether anchor in response to an electronic signal, the apparatus further comprising closing the security lock slot in response to the lock slot command comprising a close instruction.

9. The apparatus of claim 7, wherein the user credential comprises a user name and a password.

10. The apparatus of claim 7, wherein the software user interface module comprises a software interface selected from the group consisting of a BIOS user interface, an operating system user interface, an application user interface, and an electronic device configuration user interface.

11. The apparatus of claim 7, wherein the security lock slot is configured such that rotation of the latch within the security lock slot permits the latch to disengage with the security lock slot, the tether anchor further comprising a lock connecting the security tether and the latch, the lock configured to retain the latch in a locked position relative to the security lock slot and rotate the latch to an unlocked position relative to the security lock slot.

12. The apparatus of claim 7, wherein the security lock slot is configured such that rotation of the latch within the security lock slot does not permit the latch to disengage with the security lock slot, the tether anchor further comprising a lock connecting the security tether and the latch, the lock configured to retain the latch in a locked position relative to the security lock slot and rotate the latch to an unlocked position relative to the security lock slot.

13. The apparatus of claim 7, wherein the security lock slot module comprises a gate configured to raise and lower, a rack on the inside surface of the gate, and a pinion in contact with the rack, the pinion configured to turn to raise and lower the gate.

14. An system for opening a security lock slot of an electronic device, the system comprising:
a BIOS chip storing computer readable code configured to:
receive a user lock slot command and a user credential;
authenticate the user credential;
signal the security lock slot module that causes the security lock slot module to open the security lock slot to disengage the tether anchor in response to a positive authentication and the lock slot command comprising an open instruction
a processor configured to create to execute the BIOS;
a security lock slot module configured to disengage a tether anchor in response to an electronic signal, the security lock slot module having a security lock slot fixed to a housing of the electronic device, the security lock slot externally accessible by the tether anchor to secure the electronic device to the tether anchor;
a tether anchor configured to attach to the lock slot, the tether anchor comprising a T-shaped latch capable of rotation and a security tether configured to discourage theft of the electronic device.

15. The system of claim 14, wherein the security lock slot module is further configured to engage a tether anchor in response to an electronic signal, the system further comprising closing the security lock slot in response to the lock slot command comprising a close instruction.

16. The system of claim 14, wherein the user interface comprises a software interface selected from the group consisting of a BIOS user interface, an operating system user interface, an application user interface, and an electronic device configuration user interface.

17. The system of claim 14, wherein the security lock slot is configured such that rotation of the latch within the security lock slot permits the latch to disengage with the security lock slot, the tether anchor further comprising a lock connecting the security tether and the latch, the lock configured to retain the latch in a locked position relative to the security lock slot and rotate the latch to an unlocked position relative to the security lock slot.

18. The system of claim 14, wherein the security lock slot is configured such that the security lock slot does not permit the latch to rotate, the tether anchor further comprising a lock connecting the security tether and the latch, the lock configured to retain the latch in a locked position relative to the security lock slot and rotate the latch to an unlocked position relative to the security lock slot.

19. The system of claim 14, wherein the security lock slot comprises an opening sized to receive a Kensington® standard cable lock device.

20. The system of claim 14, wherein the security lock slot module comprises a gate configured to raise and lower, a rack on the inside surface of the gate, and a pinion in mechanical communication with the rack, the pinion configured to turn to raise and lower the gate.
